(19) United States
(12) Patent Application Publication
(10) Pub. No.: US 2004/0088267 A1
(43) Pub. Date: May 6, 2004

(54) System for and method of high speed postal metering of variable mass objects

(76) Inventors: Steve Rasmussen, Vancouver, WA (US); Robert Sesek, Meridian, ID (US); James D. Crumly, Boise, ID (US); Clay C. Higgins, Corvallis, OR (US); John D. Rhodes, Vancouver, WA (US); Susan M.F. Davis, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/284,850

(22) Filed: Oct. 31, 2002

(51) Int. Cl. G06F 17/00; G07B 17/02; G01G 19/413

(52) U.S. Cl. 705/407; 705/401

(57) ABSTRACT

Disclosed is a method of determining weight based delivery fees comprising determining individual weights of package elements of a parcel, determining a total weight of said parcel based on said individual weights of said package elements, and ascertaining a delivery fee associated with said total weight of said parcel.

### FIELD OF THE INVENTION

The present invention relates to software and hardware for computer systems and more specifically to software and hardware used to determine the weight of packages or letters which will be sent via a common carrier such as the U.S. postal service.

### DESCRIPTION OF RELATED ART

Distributors of advertising or informative material sent via the U.S. mail today follow a create, weigh, inform, and meter process. Typically, the information intended to be sent to the recipient is pre-printed by a service bureau, e.g., a printing company. A cover letter is addressed to the recipient and both the cover letter and the informative, advertising, and/or supplemental material are placed in an addressed envelope to be sent to the recipient. Once the letter or package is created, it is weighed and the weight is sent to a postal metering system (the inform portion of the process) which determines the postage required for the letter or package based on the service level selected. Distributors of materials today typically follow this create, weigh, inform, and meter process in the distribution of their materials. This same process is followed for each package. Thus, if a thousand packages containing identical physical material were to be sent to a thousand different addresses, a thousand packages are individually weighed, a weight per package determined, and an associated postage must be determined for each package and this postage affixed to each of the thousand similar envelopes or packages.

### BRIEF SUMMARY OF THE INVENTION

An embodiment of the present invention is directed to a method of determining weight based delivery fees comprises determining individual weights of package elements of a parcel, determining a total weight of said parcel based on the individual weights of the package elements, and ascertaining a delivery fee associated with the total weight of the parcel.

Another aspect of the invention is directed to a system for metering packages comprising a processor, a first routine executed by the processor to ascertain individual weights of a plurality of package elements, a second routine executed by the processor to calculate a total package shipping cost based on the individual weights of the plurality of package elements, and an output device connected to the processor and configured to associate the total package shipping cost with the package.

According to another aspect of the invention computer readable code stored on computer readable media is provided for determining weight based delivery fees comprising a first routine for determining the individual weights of package elements of a parcel, a second routine for determining a total weight of the parcel based on the individual weights of the package elements, and a third routine for ascertaining a delivery fee associated with the total weight of the parcel.

Another aspect of the present invention provides a method of determining delivery requirements of a parcel moving from one location to another, the parcel having a plurality of sub-parcels, comprising determining the requirements associated with each sub-parcel, and determining the total delivery requirements based on determined ones of said sub-parcel requirements.

### BRIEF DESCRIPTION OF THE DRAWINGS

FIG. 1 is a block diagram of a system for processing and metering packages according to an embodiment of the present invention;

FIG. 2 is a table data structure storing precalculated weights of package components; and

FIG. 3 is a flow chart of a method of processing and metering packages according to an embodiment of the present invention.

### DETAILED DESCRIPTION

The typical process of packaging advertising and informative materials today includes inserting the materials into an envelope, weighing the filled envelope, transferring the weight information to a metering device which, based on the total weight of the package and service level, affixes the required postage. The present invention streamlines this process by determining the weight of the package prior to its creation, creating the contents of the package, packaging the material and informing the metering device of the total calculated weight for the package so that the appropriate postage may be affixed to the package.

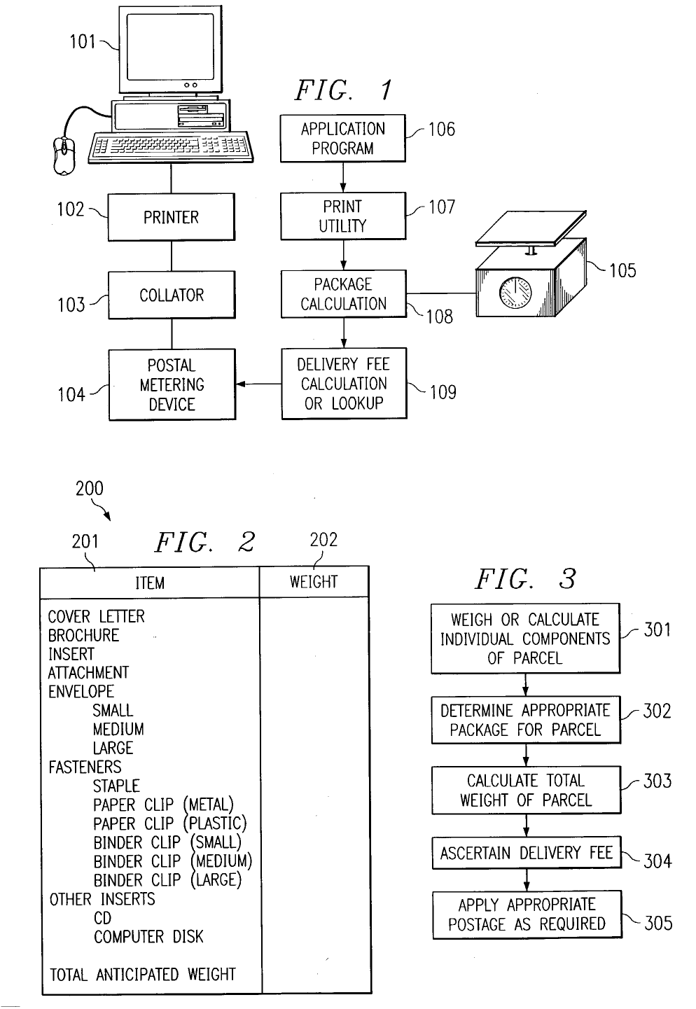

FIG. 1 illustrates one embodiment of the present invention. In FIG. 1, Computer System 101 interfaces with Printer 102 which either includes or is connected to Collator 103. Computer System 101 may be a conventional personal computer or work station running appropriate software implementing a method according to the invention. Although not shown, Computer System 101 may be networked or otherwise connected to other systems so that outgoing mailings from a number of locations are processed by the system of FIG. 1. Printer 102 may be a conventional printing device with appropriate accessories, such as Collator 103, so that material creation, collation, folding, stapling, addressing, insertion into and sealing of envelopes may be accomplished automatically. Finally, Postal Metering Device 104 is used to affix the required postage to a package, letter, or envelope which contains materials generated by Printer 102.

Computer System 101 is configured to ascertain the individual weights of the individual package elements which would be included in the mailing. The individual weights may be ascertained through a number of processes. An example mailing may consist of a cover letter, a brochure, advertising insert or other attachment, an envelope, fasteners used to attach the cover letter to the brochure, etc. Computer System 101 is configured to ascertain the individual weight of the various package elements, in this example, the weight of the cover letter, the brochure, the advertising insert or other attachments, the envelope, any fasteners used for the mailing and any additional inserts in the mailing.

The individual weights of the package elements may be determined in a number of ways. In one embodiment of the present invention, Application Program 106, such as may be resident on Computer System 101, may be used to generate the cover letter and the brochure, insert or attachment. Alternatively, other systems (not shown) may operate to create and print some or all of the materials, interfacing with Computer System 101 as necessary to provide data required to calculate the weights of the individual items to be mailed. If Application Program 106 is operational as a word processing program used to generate, for instance, the cover letter, Application Program 106 may supply the number of pages and type of media included in the cover letter to Computer System 101. For example, if the cover letter is printed on twenty pound bond media (8 ½×11), each sheet may weigh 0.01 pound. Additionally, if brochures, inserts or other attachments are generated by Application Program 106, the number of pages, sizes and types of media included in the brochure, insert or attachment are also supplied to Computer System 101. Using the number of pages, sizes and types contained in a cover letter, brochure or insert, Computer System 101 may use the weight of the paper available in Printer 102 to determine a weight of the individual package elements. Printer 102 may have several types (e.g., weights and sizes) of media loaded in various input trays). Computer System 101 may also contain or interface with a routine which is configured to calculate a total package weight based on the weight of the individual package elements. One manner in which the total package weight may be determined is through the use of a lookup table.

FIG. 2 shows one example of a simplified sample table which may be used to implement an embodiment of the present invention. Table 200 is divided into two columns. Column 201 identifies the various items which may be included in the mailing and Column 202 includes the weight associated with each of these items. The weights listed in Column 202 may be derived from Application Program 106 of FIG. 1, from actual weights of individual or composite items which have been weighed previously, or from any additional method available. Only items to be contained in the mailing would be included in the total weight of the package mailed. Once individual weights are obtained, Computer System 101 may, alone or in cooperation with an application program, calculate a total weight of the package.

Returning to FIG. 1, Application Program 106 may interface with Print Utility 107, such as may be resident on Computer System 101 or another platform (not shown) interfaced to Computer System 101. Print Utility 107 may be a print spooler and may be associated with Printer 102 to send print jobs to the printer. Alternatively, a print spooler may be resident on an intranet and may forward print jobs to various printers on the intranet. These printers may include associated facilities for assembling and applying a calculated postage to each package. Alternatively, where package assembly and/or postage metering facilities are not integrated with a printer, the system may otherwise indicate the amount of postage by generation of a cover sheet to the print job. Package Calculation 108 is used to determine the overall weight of the package, or mailing.

FIG. 2 identifies one method in which the individual component weights may be obtained and used in total weight calculation. Scale 105 may also be included in an embodiment of the current invention to determine the weights of standard package elements such as envelopes, fasteners, other inserts such as compact discs, computer diskettes, stickers, product samples or other packaged inserts which have been generated or which will be included in the package. Scale 105 may also be used to weigh completed item elements for which weight precalculation is not available. Alternative weight determining methods may also be used.

Once the total weight of the package has been determined by Package Calculation 108, such as using table 200, scale 105, and/or the like, the delivery fee (e.g., postage) is calculated or determined from a delivery fee table by Delivery Fee 109. Once the delivery fee is ascertained, Postal Metering Device 104 is informed of the required postage. Computer System 101 interfaces with Printer 102 to ensure that the cover letter, and any brochures, inserts or attachments specified by Computer System 101 are printed. Once these materials are printed they are sent to Collator 103 which combines the cover letter, inserts, and fasteners into a package, and folds and inserts the complete materials into an envelope. From Collator 103 the mailing is sent to Postal Metering Device 104 which affixes the required postage.

FIG. 3 is a flow chart showing a method of determining weight-based delivery fees including the steps of determining the individual weights of the package elements of the parcel, determining a total weight of the parcel based on the individual weights of the package elements and ascertaining a delivery fee associated with a total weight of the parcel. In step 301 the weight of each individual component of the parcel is determined. This determination may be made from a variety of methods, including using Scale 105 (FIG. 1) for standard package elements or determined from application programs used to generate package inserts such as cover letters, brochures or attachments as previously described. Once the individual weight of each of the components has been determined, step 302 determines the appropriate package for the parcel. The appropriate package for a parcel may be a small, medium, or large envelope; a box, or other similar packaging container and material. In step 303 the total weight of the parcel is calculated. The total weight of the parcel would include a cover letter, brochures, inserts or attachments, the packaging material such as envelopes, boxes, fasteners such as staples, paper clips, binder clips, mailing labels (if used) and any other insert which may be included in the mailing. In step 304, the delivery fee is ascertained from a table lookup or from Computer System 101. This could be based on transportation mode, parcel category, distance, etc. In step 305 the appropriate postage is applied to the package.

It should be noted that while the above discussion refers to physical movement of parcels, the concepts of the invention could be used for electronic delivery, where the components of the cost are data packet related as contrasted to physical movement related. Thus, for example, the different portions (sub-parcels) of a data packet could have parameters, such as fees, security codes, passwords, data type, data volume, speed, distance, delivery time, delivery location and the like, associated therewith and these costs (or other parameters) would be totaled and the proper delivery requirement could be calculated by the system. The components of the delivery requirements could, for example, be stored in a table, such as table 201.

What is claimed is:

1. A method of determining weight based delivery fees comprising:
determining individual weights of package elements of a parcel;
determining a total weight of said parcel based on said individual weights of said package elements; and
ascertaining a delivery fee associated with said total weight of said parcel.

2. The method of claim 1, wherein said step of determining the individual weights of package elements of a parcel comprises:
identifying said individual components; and
retrieving weights of said package elements.

3. The method of claim 1, wherein said step of determining the individual weights of package elements of a parcel comprises:
identifying said individual components; and
individually weighing said package elements.

4. The method of claim 1, further comprising:
generating at least one of said package elements; and
calculating a weight of said one package element based on said step of generating.

5. The method of claim 1, wherein said determining said total weight of said parcel includes summing said individual weights of said package elements to obtain said total weight of said parcel.

6. The method of claim 1, wherein said ascertaining a delivery fee associated with said total weight is determined by table lookup.

7. The method of claim 1, wherein said ascertaining a delivery fee associated with said total weight is further determined by characteristics associated with said package including one of package dimensions, shipping method, related services, origination and destination locations, applicable discount rates, and shipping methods.

8. A system for metering packages comprising:
a processor;
a first routine executed by said processor to ascertain individual weights of a plurality of package elements;
a second routine executed by said processor to calculate a total package shipping cost based on said individual weights of said plurality of package elements; and
an output device connected to said processor and configured to associate said total package shipping cost with said package.

9. The system of claim 8 wherein said processor is connected to a weighing device to receive information representative of a weight of at least one of said package elements.

10. The system of claim 8 wherein said processor is further connected to receive, from an application program, a parameter value related to a weight of at least one of said package elements wherein said application program is used to create said one of said package elements.

11. The system of claim 8 wherein said parameter values includes one of a page count, a paper size, a binding method, and a paper weight.

12. The system of claim 8 wherein said first routine implements a table lookup to ascertain said individual weights of said package elements.

13. The system of claim 8 wherein said second routine calculates said total package shipping cost by summing said individual weights to obtain a total package shipping weight.

14. The system of claim 8 wherein said second routine calculates said total package shipping cost further based on characteristics associated with said package including one of package dimensions, shipping method, related services, origination and destination locations, applicable discount rates, and shipping methods.

15. Computer readable code stored on computer readable media for determining weight based delivery fees comprising:
a first routine for determining individual weights of package elements of a parcel;
a second routine for determining a total weight of said parcel based on said individual weights of said package elements; and
a third routine for ascertaining a delivery fee associated with said total weight of said parcel.

16. The computer readable code stored on computer readable media of claim 15, wherein said first routine of determining the individual weights of package elements of a parcel includes a routine for:
identifying said individual components and retrieving weights of said package elements.

17. The computer readable code stored on computer readable media of claim 15, wherein said first routine of determining the individual weights of package elements of a parcel includes a routing for:
identifying said individual components and individually weighing said package elements.

18. The computer readable code stored on computer readable media of claim 15, further comprising:
a fourth routine for generating at least one of said package elements; and
a fifth routine for calculating a weight of said one package element based on said generating said at least one of said package elements.

19. The computer readable code stored on computer readable media of claim 15, wherein said third routine for ascertaining a delivery fee associated with said total weight is determined by table lookup.

20. The computer readable code stored on computer readable media of claim 15, wherein said third routine for ascertaining a delivery fee associated with said total weight further includes characteristics associated with said package including one of package dimensions, shipping method, related services, origination and destination locations, applicable discount rates, and shipping methods.

21. A method of determining delivery requirements of a parcel moving from one location to another, said parcel having a plurality of sub-parcels, comprising:
determining the requirements associated with each sub-parcel; and
determining the total delivery requirements based on determined ones of said sub-parcel requirements.

22. The method of claim 21 wherein said delivery requirements are fees.

23. The method of claim 22 wherein said delivery is a physical movement of said parcel and said fees are based, at least in part, on weight of said parcel based upon said total delivery requirements.

24. The method of claim 21 wherein said delivery is electronic.

25. The method of claim 24 wherein said delivery requirements are fees.

26. The method of claim 24 wherein said delivery requirements are other parameters associated with said sub-parcels.

27. The method of claim 26 wherein said parameters are selected from the list comprising fees, security codes, passwords, data type, data volume, data speed, distance, delivery time, and delivery location.
